(19) United States
(12) Patent Application Publication
(10) Pub. No.: US 2016/0134800 A1
(43) Pub. Date: May 12, 2016

(54) RECEPTACLE FOR A COMPUTING DEVICE THAT PERFORMS IMAGE CAPTURE

(71) Applicant: iOgrapher, LLC, San Gabriel, CA (US)

(72) Inventors: David Basulto, San Gabriel, CA (US); Jason Ivey, Irvine, CA (US)

(21) Appl. No.: 14/995,695

(22) Filed: Jan. 14, 2016

Related U.S. Application Data
(63) Continuation-in-part of application No. 13/895,349, filed on May 15, 2013.
(60) Provisional application No. 61/768,751, filed on Feb. 25, 2013.

(51) Int. Cl. H04N 5/232; H04N 5/225

(52) U.S. Cl. CPC H04N 5/2328; H04N 5/2252

(57) ABSTRACT

An apparatus is provided. The apparatus has a receptacle configured to receive an image capture computing device and at least one wire that is connectable to the image capture computing device. Further, the apparatus has a first handle that is operably connected to the receptacle and is curved such that the at least one wire is connected directly to the image capture device without obstruction from the first handle. In addition, the apparatus has a second handle that is operably connected to the receptacle.

### RELATED APPLICATIONS

This patent application is a Continuation-In-Part application of U.S. patent application Ser. No. 13/895,349, filed on May 15, 2013, entitled RECEPTACLE FOR AN IMAGE CAPTURE COMPUTING DEVICE, which claims priority to U.S. Provisional Patent Application Ser. No. 61/768,751, filed on Feb. 25, 2013, entitled A PLASTIC CASE FOR THE IPAD MINI AND IPAD. IT HAS HANDLES ON THE SIDES, 3 ACCESSORY SHOE AREAS, A TRIPOD MOUNT, AND THE ABILITY TO SCREW ON 37 MM LENSES, which are hereby incorporated by reference in their entireties.

### BACKGROUND

1. Field

This disclosure generally relates to the field of image capture. More particularly, the disclosure relates to a stabilization configuration for a receptacle for a mobile computing device that performs image capture.

2. General Background

Standard cameras typically allow for utilization of a tripod. For example, a photographer can place a standard camera on a tripod so that movement of the camera during image capture is minimized. The tripod allows a photographer using a standard camera to take pictures without using both hands to stabilize the camera.

Current mobile computing devices, e.g., tablet devices, smartphones, etc., provide image capture capabilities, e.g., still or motion, that are comparable with standard image capture devices such as standard cameras. Yet the picture quality from such mobile computing devices is often of a lesser quality than that of standard cameras as standard cameras provide users with firmer stabilization abilities than a mobile computing device. Users often have difficulty keeping the mobile computing device stable during image capture. The mobile computing device often wobbles during the image capture, which then results in pictures or videos that are often of a less than ideal quality.

Further, many applications utilized by mobile computing devices necessitate a particular orientation for image capture. For instance, many social networking applications configured for utilization by mobile computing devices will only display pictures in a particular format, e.g., a user has to scroll vertically rather than horizontally through pictures. A user has to take pictures in a manner consistent with that format to avoid having to crop the pictures. For example, the user would have to crop pictures taken with a mobile computing device horizontally for an application that displays those pictures vertically. The necessity of cropping and/or other image modification techniques may diminish the quality of the captured image.

Although the vertical format is necessary for image capture for many applications, the vertical format provides less stabilization for a user than the horizontal format. A user may have more difficulty stabilizing a mobile computing device vertically rather than horizontally as the vertical configuration has a lesser width for positioning of the hands of the user than the horizontal configuration. As a result, current mobile computing devices provide limited capabilities to photographers.

### SUMMARY

In one aspect of the disclosure, an apparatus is provided. The apparatus has a receptacle configured to receive an image capture computing device and at least one wire that is connectable to the image capture computing device. Further, the apparatus has a first handle that is operably connected to the receptacle and is curved such that the at least one wire is connected directly to the image capture device without obstruction from the first handle. In addition, the apparatus has a second handle that is operably connected to the receptacle.

In another aspect of the disclosure, an apparatus is provided. The apparatus has a receptacle configured to receive an image capture computing device, a first wire that is connectable to a first side of the image capture computing device, and a second wire that is connectable to a second side of the image capture computing device. Further, the apparatus has a first handle that is operably connected to the first side of the receptacle and is curved such that the first wire is connected directly to the first side of the image capture device without obstruction from the first handle. In addition, the apparatus has a second handle that is operably connected to the second side of the receptacle and is curved such that the second wire is connected directly to the second side of the image capture device without obstruction from the second handle.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a front view of an image capture computing device receptacle.

FIG. 2 illustrates a back view of the image capture computing device receptacle.

FIG. 3 illustrates a side view of the receiving means.

FIG. 4 illustrates a front view of the image capture computing device receptacle with a mobile computing device secured to the image capture computing device receptacle.

FIG. 5 illustrates a front view of the image capture computing device receptacle 100 with the mobile computing device secured to the image capture computing device receptacle and the image capture computing device receptacle having a bottom handle.

FIG. 6 illustrates a front view of the image capture computing device receptacle with the mobile computing device secured to the image capture computing device receptacle and the image capture computing device receptacle only having the right handle for a handle.

FIG. 7 illustrates a front view of an image capture computing device receptacle that is configured to receive a smartphone.

FIG. 8 illustrates a back view of the image capture computing device receptacle illustrated in FIG. 7.

FIG. 9A illustrates a front perspective view of the flat handle configuration of the image capture computing device receptacle.

FIG. 9B illustrates a front view of the flat handle configuration of the image capture computing device receptacle illustrated in FIG. 9A.

FIG. 9C illustrates a side view of the flat handle configuration of the image capture computing device receptacle illustrated in FIG. 9A.

FIG. 9D illustrates another side view of the flat handle configuration of the image capture computing device receptacle illustrated in FIG. 9A.

FIG. 10A illustrates a rear perspective view of the curved handle configuration of the image capture computing device receptacle.

FIG. 10B illustrates a top view of the curved handle configuration of the image capture computing device receptacle.

FIG. 10C illustrates a side view of the curved handle configuration of the image capture computing device receptacle.

FIG. 10D illustrates a front view of the curved handle configuration of the image capture computing device receptacle.

### DETAILED DESCRIPTION

A receptacle for a computing device that performs image capture is provided. The image capture computing device is received by the receptacle. A user then grasps the receptacle and motions the receptacle to a position for image capture. The receptacle has handles that provide for stabilization of the receptacle and the image capture computing device. As a result, users performing image capture have the ability to capture still images and/or video images with stabilization. In contrast with heavy receptacles that do not have handles, the receptacle for the image capture computing device provides a lightweight configuration that provides stabilization for an image capture computing device.

Further, the receptacle is configured to provide optimal accessibility to various ports of the mobile computing device. In contrast with a configuration in which wires have to be bent in a manner that may damage the wires and be cumbersome for a user, the receptacle is configured to maximize accessibility to the mobile computing device and minimize interference from the wires.

In addition, the receptacle may have additional components that allow the user performing image capture to vary image capture conditions. For example, the receptacle may receive a variety of lenses that may be utilized to vary viewing conditions. Further, various lighting and/or audio equipment may be positioned on the receptacle to vary lighting and/or audio conditions. The receptacle may also have a tripod component so that the receptacle may be stabilized with a tripod to minimize motion of the image capture computing device during image capture.

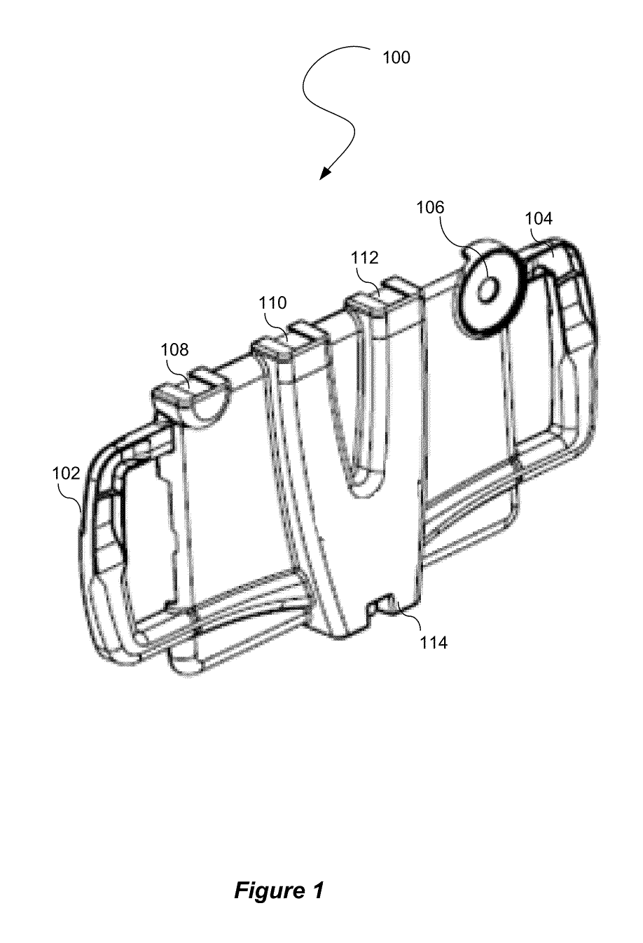

FIG. 1 illustrates a front view of an image capture computing device receptacle 100. In one embodiment, the image capture computing device receptacle 100 includes a plurality of handles, e.g., a right handle 102 and a left handle 104. The front of the image capture computing device receptacle 100 is illustrated from the perspective of what another user views if in front of the image capture computing device 100 when an image is captured by a user such as a photographer. The right handle 102 and the left handle 104 allow the user to perform image capture with minimal wobbling. As a result, the photographer is able to perform image capture with more stabilization and accuracy than without the image capture computing device receptacle 100. Although the right handle 102 and the left handle 104 are illustrated, the handles may be in other locations, e.g., a top handle and a bottom handle. Further, a single handle or more than two handles may be utilized. The right handle 102 and the left handle 104 are provided merely for illustrative purposes.

The image capture computing device receptacle 100 also has an aperture 106. The aperture 106 is configured so that an image capture component, e.g., a lens of a mobile image capture computing device, may be positioned to capture images through the aperture 106. In one embodiment, the aperture 106 is configured to be in substantial proximity to the image capture component. For example, the aperture may be narrow enough to only be positioned over the lens to minimize reflection.

In another embodiment, the image capture computing device receptacle 100 has a plurality of accessory receiving means. As an example, the image capture computing device receptacle 100 has a receiving means 108, a receiving means 110, a receiving means 112, and a receiving means 114. The various receiving means may be utilized to receive accessories such as lighting devices, e.g., lamps, audio devices, e.g., microphones, additional lenses, e.g., wide angle lenses, tripods, and/or the like. For example, the receiving means 114 may receive a tripod mount to provide further stabilization for the image capture computing device receptacle 100 with a tripod. A single or different quantity of receiving means may be utilized from that illustrated in FIG. 1.

In one embodiment, the right handle 102 and the left handle 104 are integrated within the same frame as the image capture computing device receptacle 100. In other words, a single molding may be utilized for the frame and the handles. In an alternative embodiment, the right handle 102 and the left handle are detachable from the frame.

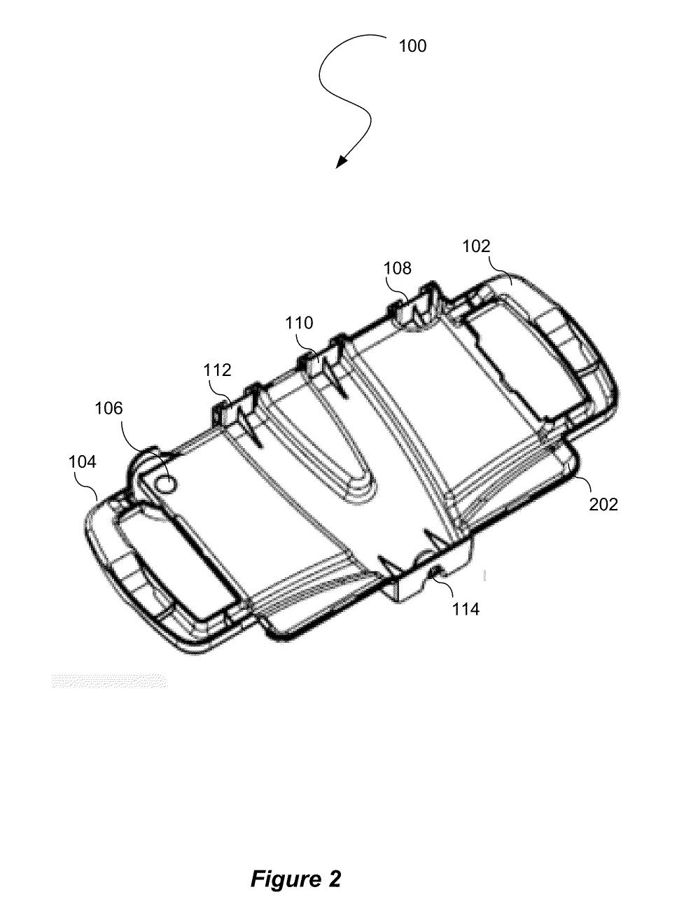

FIG. 2 illustrates a back view of the image capture computing device receptacle 100. The back view is from the perspective of the photographer that is placing the mobile computing device in the image capture computing device receptacle 100. In one embodiment, the image capture computing device receptacle 100 has a receiving means for receiving the image capture computing device receptacle 100. An example of the receiving means is the lip 202. The lip 202 may be positioned throughout all of the frame or at least a portion of the frame. A photographer may then snap the mobile computing device within the lip to secure the mobile computing device in the image capture computing device receptacle 100. As a result, the photographer may easily snap the mobile computing device into position. The lip is only an example of the receiving means. The receiving means may also be a fastening means such as a screw, bolt, nail, clip, and/or the like.

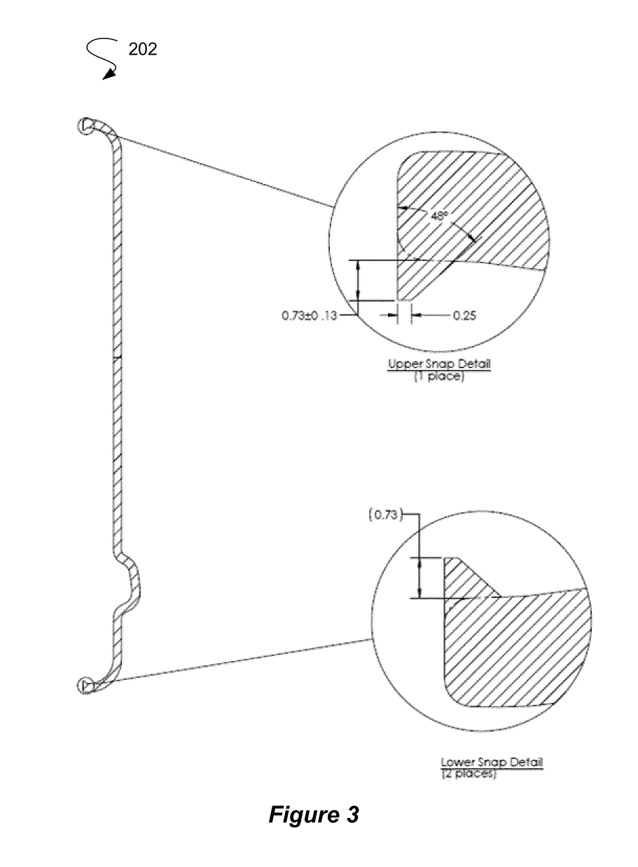

FIG. 3 illustrates a side view of the receiving means 202. The receiving means 202 is illustrated as a lip only for illustrative purposes as various other receiving means may be utilized.

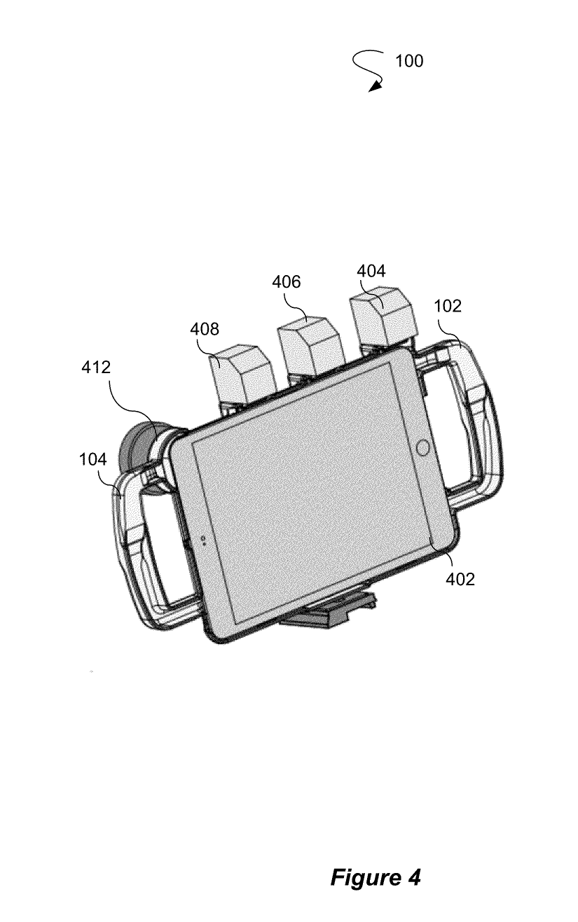

FIG. 4 illustrates a front view of the image capture computing device receptacle 100 with a mobile computing device 402 secured to the image capture computing device receptacle 100. The mobile computing device 402 may be a tablet device, smartphone, or any other mobile device. Further, the mobile computing device 402 may have an image capture component, e.g., a built in camera, for still or motion image capture. Various accessories 404, 406, and 408 may be connected to the receiving means 108, 110, and 112. The receiving means 108, 110, and 112 may be a lip, screw, bolt, nail, clip, and/or the like. Further, a lens accessory 412 is positioned over the aperture 106.

Although a frame single frame is illustrated in FIG. 4, multiple frames may alternatively be utilized to secure the mobile computing device 402. In other words, the image capture computing device receptacle 100 may comprise multiple parts such as a front portion and a back portion to secure the mobile computing device 402 to the image capture computing device receptacle 100. Accordingly, the image capture computing device receptacle 100 is not limited to a single frame as multiple frames may alternatively be utilized.

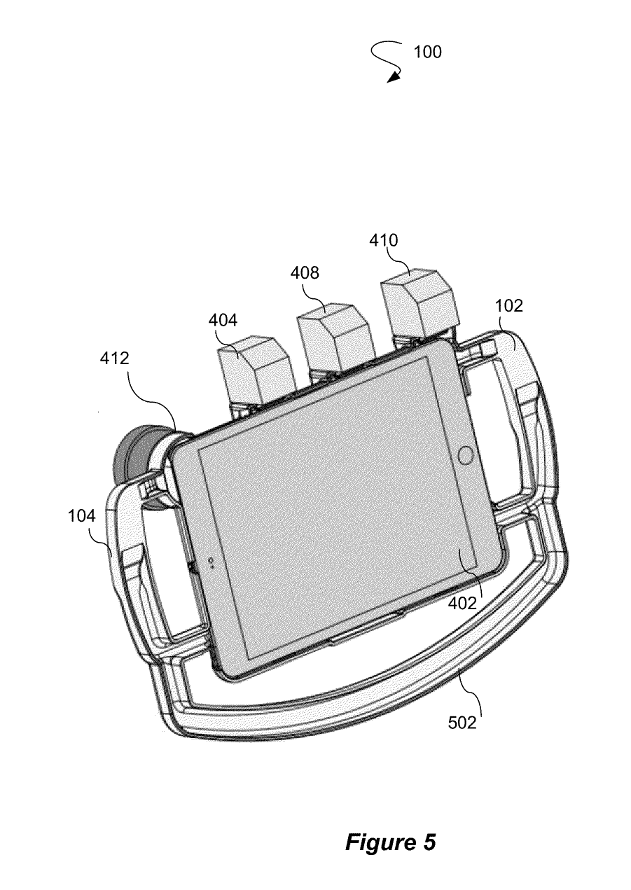

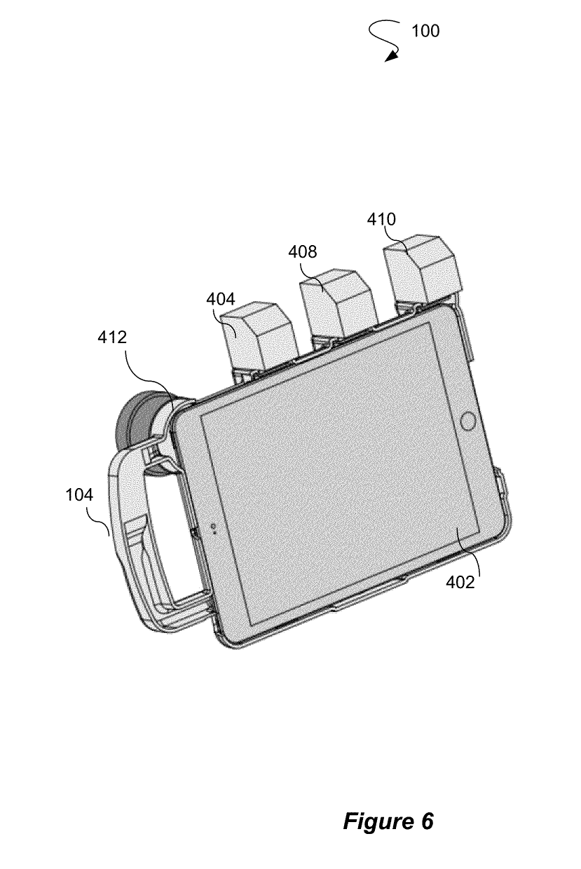

Although FIGS. 1-4 illustrated two handles, a single handle or more than two handles may be utilized. FIG. 5 illustrates a front view of the image capture computing device receptacle 100 with the mobile computing device 402 secured to the image capture computing device receptacle 100 and the image capture computing device receptacle 100 having a bottom handle 502. Alternatively, the right handle 102, the left handle 104, and the bottom handle 502 may be considered a single handle. Further, FIG. 6 illustrates a front view of the image capture computing device receptacle 100 with the mobile computing device 402 secured to the image capture computing device receptacle 100 and the image capture computing device receptacle 100 only having the left handle 104 for a handle.

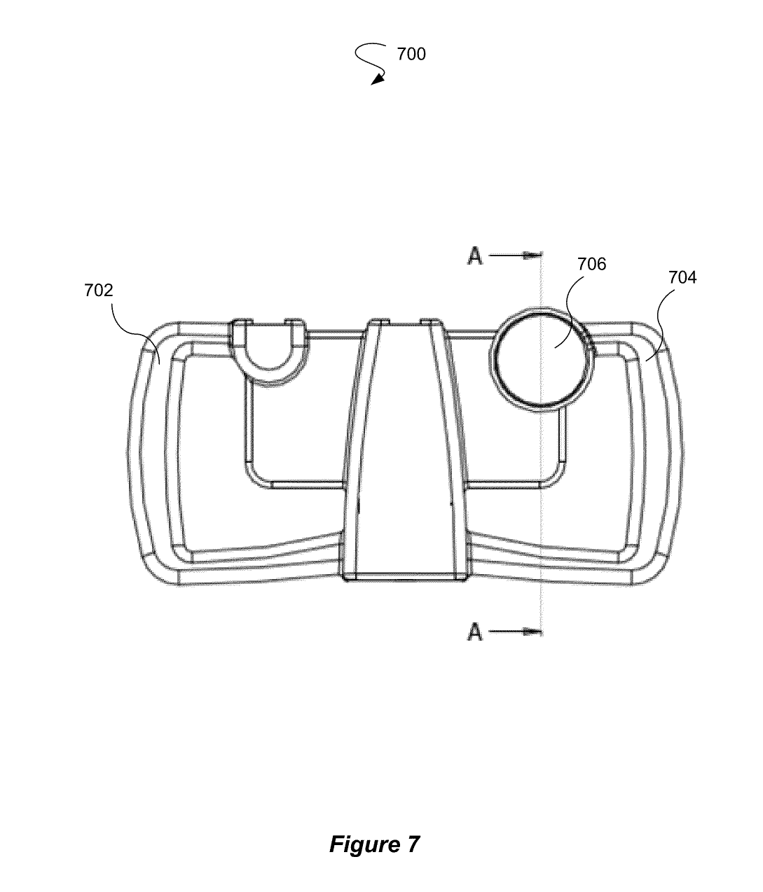

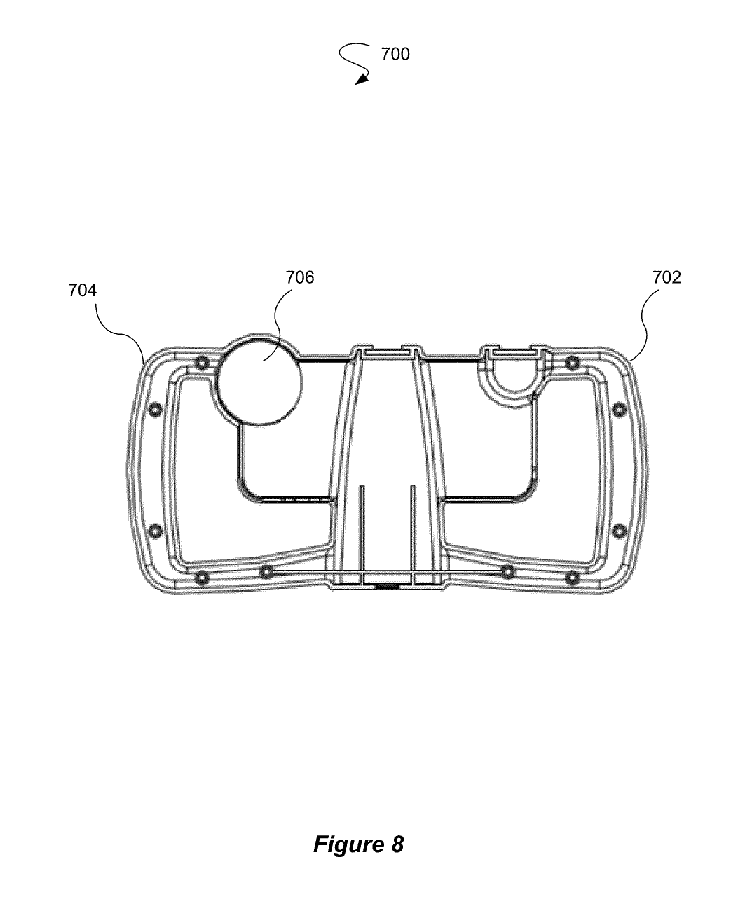

Although FIGS. 4-6 illustrate the mobile computing device 402 as a tablet device, a smartphone may alternatively be utilized. Accordingly, FIG. 7 illustrates a front view of an image capture computing device receptacle 700 that is configured to receive a smartphone. The image capture computing device receptacle 700 has a right handle 702 and a left handle 704. The image capture computing device receptacle 700 also has an aperture 706. FIG. 8 illustrates a back view of the image capture computing device receptacle 700 illustrated in FIG. 7.

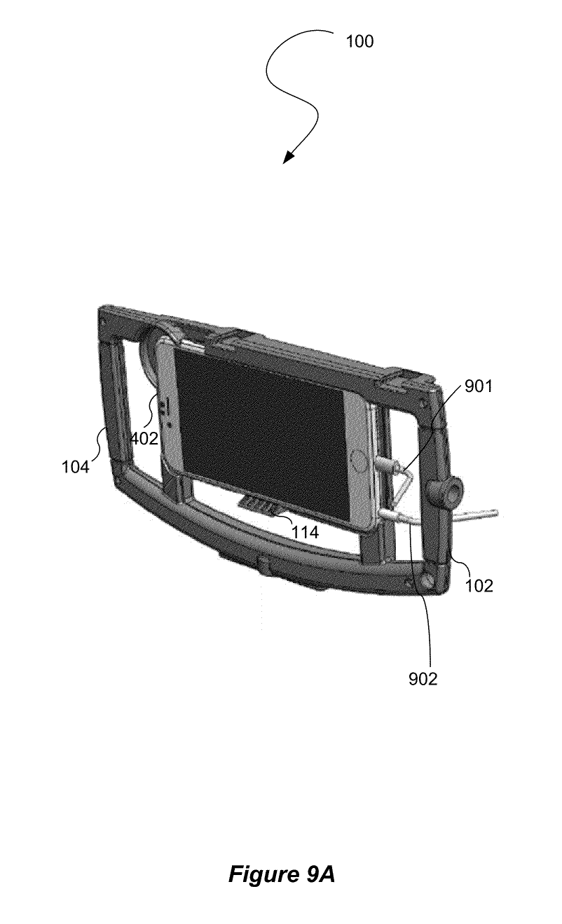

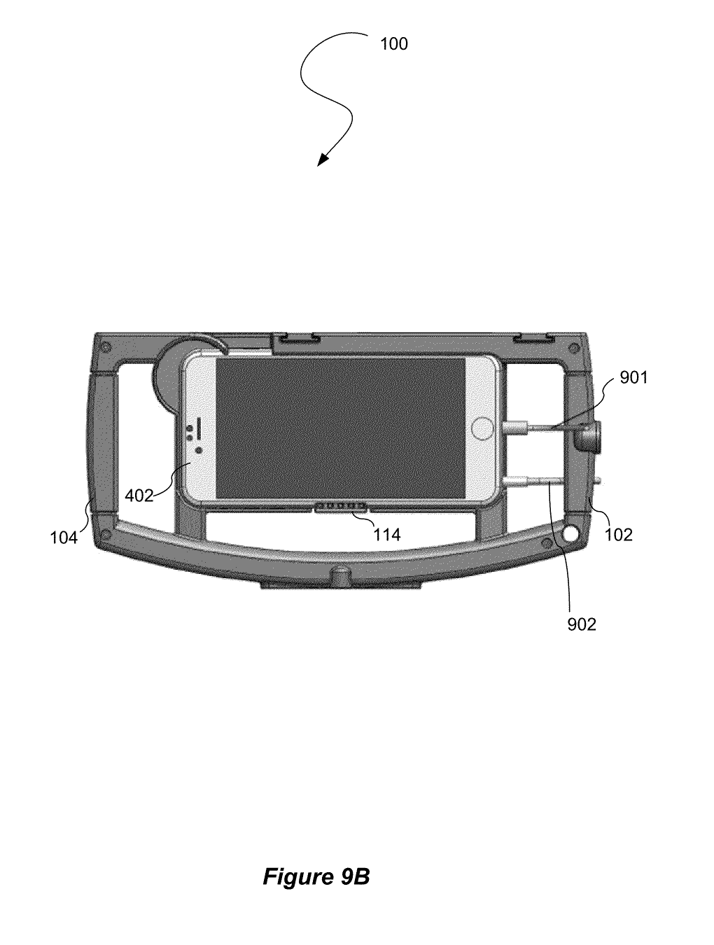

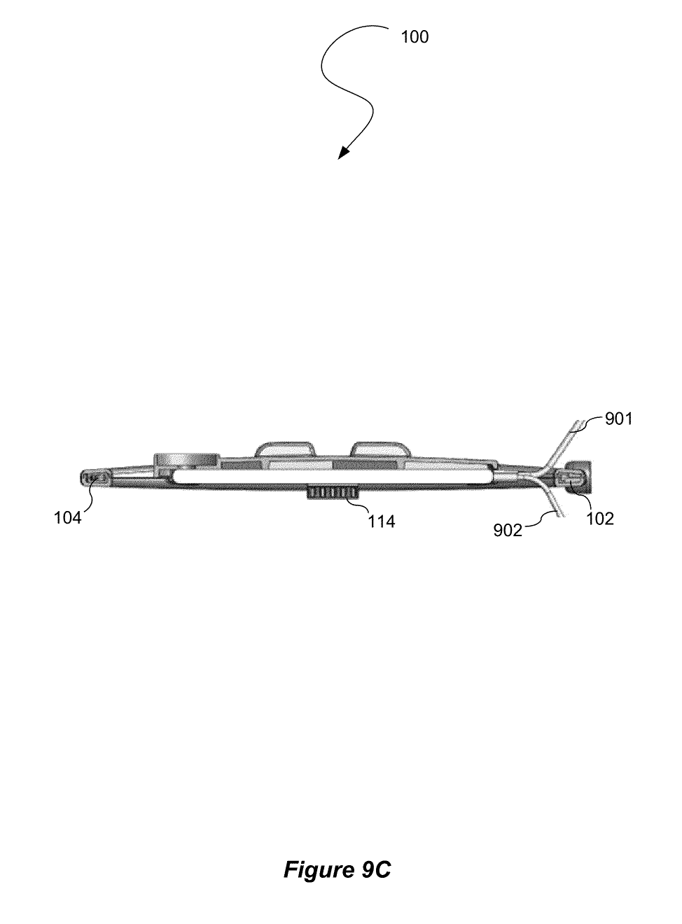

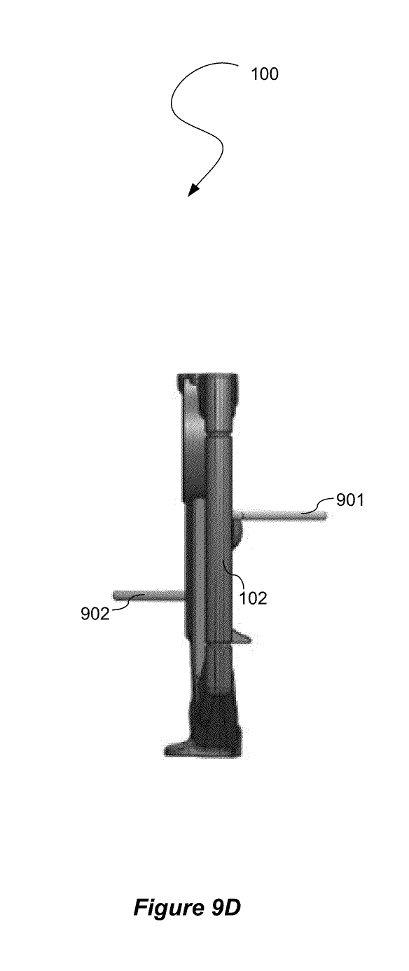

FIGS. 9A-9D illustrate various views of a flat handle configuration of the image capture computing device receptacle 100 illustrated in FIG. 1. The flat handle configuration has handles that are in vertical alignment with the vertical plane that goes through the image capture computing device receptacle 100. As a result various wires that are plugged into the mobile computing device 402 of FIG. 4 have to be bent, twisted, etc. to have accessibility to receiving ports of the mobile computing device 402 of FIG. 4. Such wires may be utilized to connect the image capture computing device 100 to various accessories, other devices, etc. The ports may be based on various technologies such as USB, Ethernet, etc.

FIG. 9A illustrates a front perspective view of the flat handle configuration of the image capture computing device receptacle 100. The right handle 102 and the left handle 104 are in vertical alignment with the image capture computing device receptacle 100. As a result, a lighting cable 901 and a headphone cable 902 do not have direct accessibility to receiving ports of the mobile computing device 402. Therefore, the cables 901 and 902 have to be significantly bent, e.g., at approximate ninety degree angles, to obtain access to the receiving ports of the mobile computing device 402 of FIG. 4.

Such awkward bending may lead to significant damage or wear and tear of the cables 901 and 902. Further, the cables 901 and 902 may easily become unplugged from the receiving ports of the mobile computing device 402 of FIG. 4 as such bending does not allow for secure plugging of the cables 901 and 902. Such unplugging may lead to significant disruptions during filming, image capture, etc.

Further, the bending of the cables 901 and 902 interferes with a user's ability to comfortably grip the handles 102 and 104. For example, the bends of the cables 901 and 902 may occupy significant amounts of gripping space between the handles 102 and 104 and the portion of the image capture computing device receptacle 100 that encapsulates the mobile computing device 402. As a result, the bends of the cables 901 and 902 may block certain portions of the handles 102 and 104 from being gripped by the user.

FIG. 9B illustrates a front view of the flat handle configuration of the image capture computing device receptacle 100 illustrated in FIG. 9A. Further, FIG. 9C illustrates a side view of the flat handle configuration of the image capture computing device receptacle 100 illustrated in FIG. 9A. The cables 901 and 902 are illustrated as being significantly bent at almost ninety degree angles. In addition, FIG. 9D illustrates another side view of the flat handle configuration of the image capture computing device receptacle 100 illustrated in FIG. 9A.

The lighting cable 901 and the headphone cable 902 are only provided as examples of cables that may be utilized with the receiving ports of the mobile computing device 402. Other types of cables may also be utilized. Further, devices other than cables that may be received by the mobile computing device 402, e.g., USB devices, etc., may also be received by the receiving ports of the mobile computing device 402.

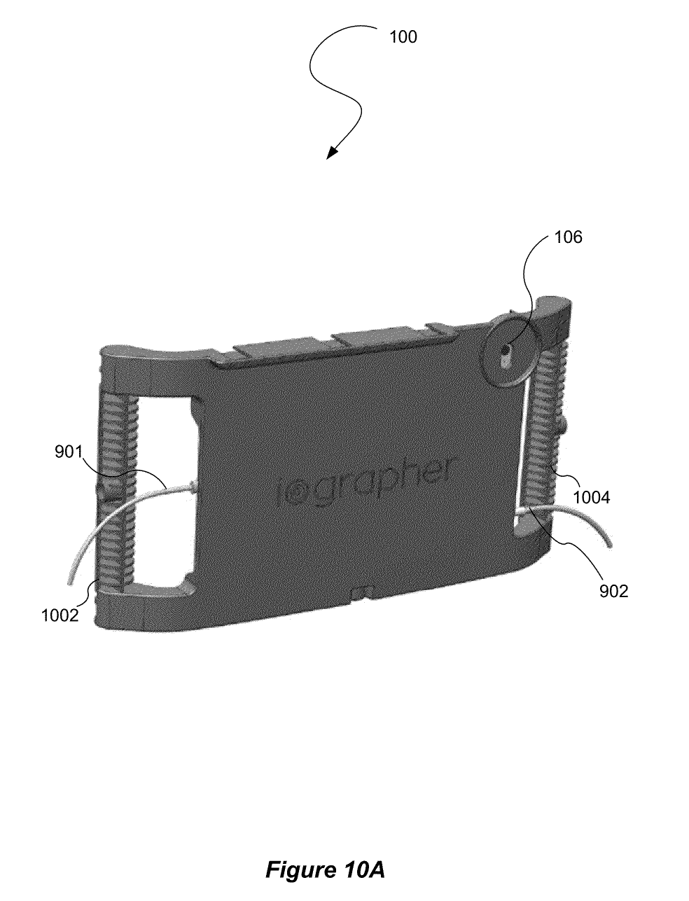

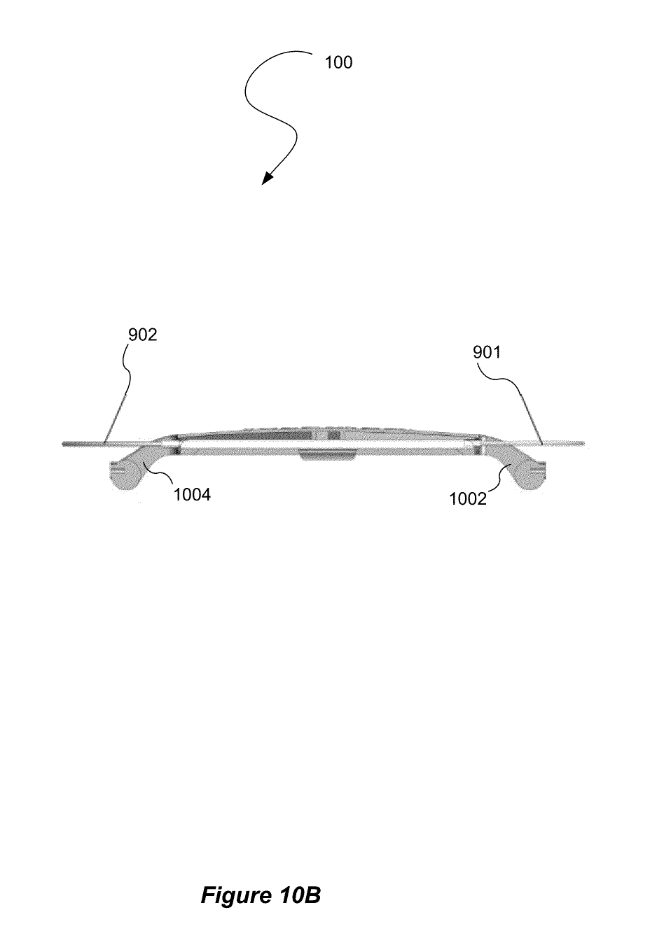

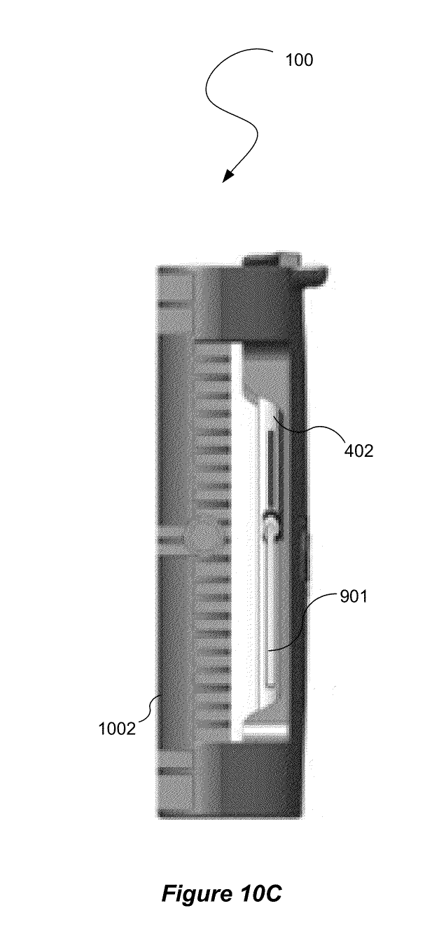

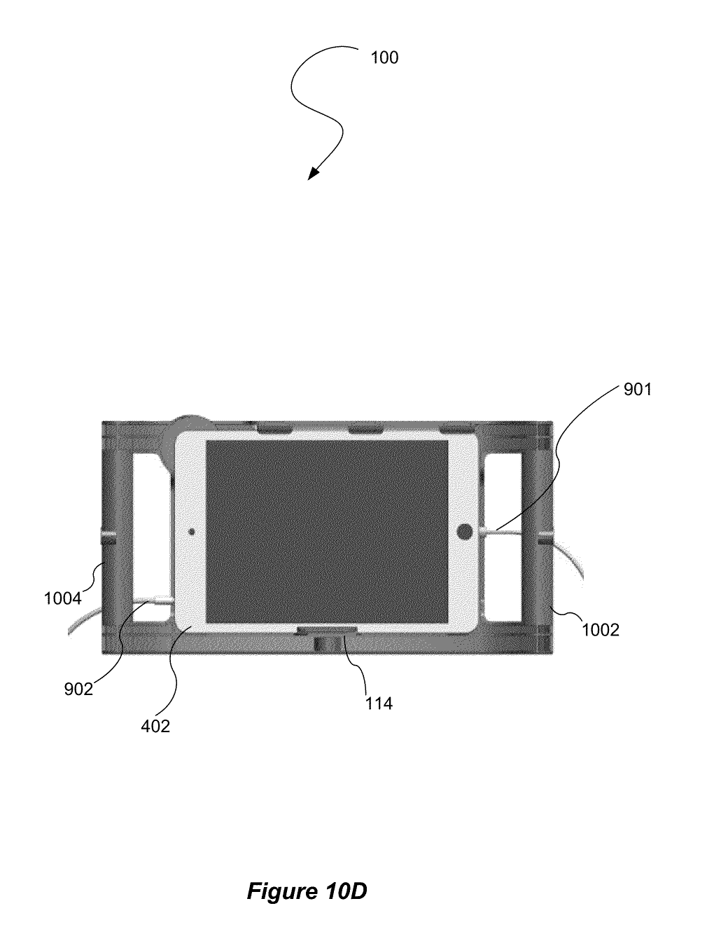

FIGS. 10A-10D illustrate various views of a curved handle configuration of the image capture computing device receptacle 100 illustrated in FIG. 1. The curved handle configuration has a right curved handle 1002 and a left curved handle 1004. The curved handles 1002 and 1004 may or may not have ribbed configurations for gripping the curved handles 1002 and 1004.

FIG. 10A illustrates a rear perspective view of the curved handle configuration of the image capture computing device receptacle 100. The curved handles 1002 and 1004 have a curvature that allows direct accessibility for the cables 901 and 902 to the receiving ports of the mobile computing device 402. In other words, the curvature of the curved handles 1002 and 1004 is such that the cables 901 and 902 may have horizontal alignment with the horizontal plane of the mobile computing device 402. The curvature may be at angles of approximately ten degrees to ninety degrees.

FIG. 10B illustrates a top view of the curved handle configuration of the image capture computing device receptacle 100. The cables 901 and 902 are plugged into receiving ports of the mobile computing device 402 without any bending, twisting, etc. as the curved handles 1002 and 1004 do not interfere with the accessibility of the cables 901 and 902 to the mobile computing device 402. In other words, the curved handles 1002 and 1004 are not an obstruction for the cables 901 and 902.

FIG. 10C illustrates a side view of the curved handle configuration of the image capture computing device receptacle 100. The curvature of the right curved handle 1002 allows for direct accessibility for the cable 901 to the receiving port of the mobile computing device 402 and space for the user to grip the right curved handle 1002 without interference from the right curved handle 1002. FIG. 10D illustrates a front view of the curved handle configuration of the image capture computing device receptacle 100.

The configurations provided for herein allow a user to avoid the inefficiencies of the process of prior configurations of mounting, removing, and remounting a mobile computing device from a mounting configuration. The configurations provided for herein allow a user to perform image capture functionality and non-image capture functionality with the image capture computing device without removing the image capture computing device from the image capture computing device receptacle 100. As a result, a user has fewer interruptions while performing image capture and non-image capture functionality with the image capture computing device receptacle 100, which may lead to a more efficient and accurate image capture than prior configurations.

In various embodiments, the actuators for any of the configurations may be situated on the handles 102 and 104. In various other embodiments, the actuators for any of the configurations may be situated on the image capture receptacle 100.

A variety of types of materials may be utilized for the image capture computing device receptacles. For example, plastic, carbonite, metal, or the like may be utilized.

It is understood that the apparatuses described herein may also be applied in other types of apparatuses. Those skilled in the art will appreciate that the various adaptations and modifications of the embodiments of the apparatuses described herein may be configured without departing from the scope and spirit of the apparatuses. Therefore, it is to be understood that, within the scope of the appended claims, the present apparatuses may be practiced other than as specifically described herein.

We claim:

1. An apparatus comprising:
a receptacle configured to receive an image capture computing device and at least one wire that is connectable to the image capture computing device;
a first handle that is operably connected to the receptacle and is curved such that the at least one wire is connected directly to the image capture device without obstruction from the first handle; and
a second handle that is operably connected to the receptacle.

2. The apparatus of claim 1, wherein the image capture computing device has a port that receives the at least one wire.

3. The apparatus of claim 2, wherein the port is a USB port.

4. The apparatus of claim 2, wherein the port is an Ethernet port.

5. The apparatus of claim 1, wherein the receptacle has an aperture through which a lens of the image capture component is positioned.

6. An apparatus comprising:
a receptacle configured to receive an image capture computing device, a first wire that is connectable to a first side of the image capture computing device, and a second wire that is connectable to a second side of the image capture computing device;
a first handle that is operably connected to the first side of the receptacle and is curved such that the first wire is connected directly to the first side of the image capture device without obstruction from the first handle; and
a second handle that is operably connected to the second side of the receptacle and is curved such that the second wire is connected directly to the second side of the image capture device without obstruction from the second handle.

7. The apparatus of claim 6, wherein the image capture computing device has a first port that receives the first wire.

8. The apparatus of claim 6, wherein the image capture computing device has a second port that receives the second wire.

9. The apparatus of claim 6, wherein the first handle and the second handle have ribbed configurations.

10. The apparatus of claim 6, wherein the receptacle has an aperture through which a lens of the image capture component is positioned.
